(19) United States
(12) Patent Application Publication
(10) Pub. No.: US 2010/0098821 A1
(43) Pub. Date: Apr. 22, 2010

(54) Process for Solubilization of Flavor Oils

(76) Inventors: Bob Comstock, Singapore (SG); Mei Yin Wang, Singapore (SG); Nelly Lim, Singapore (SG)

Correspondence Address: STEFAN KIRCHANSKI, VENABLE LLP 2049 CENTURY PARK EAST, 21ST FLOOR, LOS ANGELES, CA, 90067, US

(21) Appl. No.: 12/442,794

(22) PCT Filed: Apr. 18, 2007
(86) PCT No.: PCT/US07/66861

§ 371 Date: Jun. 2, 2009

Related U.S. Application Data
(60) Provisional application No. 60/826,766, filed on Sep. 25, 2006.
(60) Provisional application No. 60/828,205, filed on Oct. 4, 2006.

(51) Int. Cl. A23L 2/56; A23L 2/385; A23L 2/39; A23L 2/70

(52) U.S. Cl. 426/330.3

(57) ABSTRACT

The inventive process allows the solubilization of flavor oil in water to produce clear beverages. The amount of emulsifier required for oil solubilization is less than that of oil, and a typical oil to emulsifier ratio is 2:1. A crude emulsion is first generated by high shear mixing of the emulsifier solution and flavor oil. The crude emulsion is then fed into a homogenizer to produce a finer emulsion. The resulting flavor concentrate can then be diluted to produce clear beverages. This process also simplifies the introduction of normally insoluble nutraceuticals, particularly lipophilic ones, into beverages. Compared to microemulsion formulations, this process provides an easy way of formulation customization to different flavors and nutraceuticals.

### CROSS-REFERENCE TO PRIOR APPLICATIONS

The present application is a non-provisional version of U.S. Provisional Patent Applications No. 60/826,766 (filed 25 Sep. 2006) and 60/828,205 (filed 4 Oct. 2006) and claims benefit and priority from these applications.

### U.S. GOVERNMENT SUPPORT

N/A

### BACKGROUND OF THE INVENTION

1. Area of the Art

This invention relates to a process that solubilizes essential oils to produce clear beverages.

2. Background

Many flavoring agents in beverage preparation are essential oils that are generally water insoluble. The common flavors such as orange, lemon and grapefruit have limited solubility in water. However, these flavors are well received by the consumers due to desirable aroma and flavor, particularly in beverages.

There are several industrial practices to introduce these oils into water. A major technique is to wash/extract the essential oil with a water-miscible solvent to remove the bulk of water insoluble components. In this washing process, the water soluble or polar components of the oil are extracted and this extract can be used to create clear beverages. However, this process does not preserve the full aroma and flavor of the essential oil, and the “freshness” of flavors such as those provided by citrus oils is reduced. Another common technique used is to formulate the essential oils into microemulsions. These microemulsions comprise about 30% essential oil, 20-50% surfactant with the remainder being food grade solvent such as glycerol, propylene glycol, ethanol or even water. Most of these microemulsions also contain ethoxylated surfactants like polysorbates. The use of polysorbates presents taste as well as regulatory issues. Although microemulsions form spontaneously, the relative amounts of oil, surfactants and solvents are crucial to their formation. Because the composition of a given flavor oil depends on its origin and processing, microemulsions have to be tailored to cater to oil differences. In addition, solid flavor delivery systems have also been developed that allows the dispersion of flavor in beverages. In these systems, hydrocolloids and/or starches are used as carriers. A draw back of these systems is that the flavor loading is limited. For example, U.S. Pat. No. 4,707,367 (Miller et al.) discloses a system where the solids contain an average of only 20% by weight flavor.

With the gaining popularity of functional drinks, nutraceuticals such as Coenzyme Q10, omega-3 fatty acids, vitamins and carotenoids are supplemented in beverages. Many of these nutraceuticals are lipophilic in nature and possess limited water solubility. If the targeted end product is a clear beverage, these nutraceuticals have to be formulated into a water-soluble form before introduction into the beverage.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide an improved process for solubilization of flavor oils.

Our improved process for incorporating flavor oils into clear beverages uses a high pressure homogeniser along with high hydrophilic-lipophilic balance (HLB) emulsifiers to solubilize flavor oils allowing brighter, fresher beverages without washing/extraction or necessary inclusion of cosolvents as is common in the industry. Besides resulting in superior oil solubilization, this process also reduces the amount of emulsifier required to solubilize an oil.

In the process, a single emulsifier or a blend of emulsifiers can be used to achieve optically clear beverages flavored with single fold oils especially citrus flavors such as orange, lemon and lime. Besides single fold oil, this technology also works for flavor bases that comprise mixtures of natural flavor oils and synthetic flavorings.

A wide variety of emulsifiers may be used in the process. The emulsifiers that may be used are summarized in Table 1.

TABLE 1

| Type | Emulsifier Name |
|---|---|
| Ionic | Salts of fatty acids such as myristic acid, palmitic acid, |
| | stearic acid, oleic acid |
| | Monoglyceride ester of diacetyltartaric acid |
| | Diglyceride ester of diacetyltartaric acid |
| | Monoglyceride ester of citric acid and salts thereof |
| | Diglyceride ester of citric acid |
| | Monoglyceride ester of lactic acid |
| | Diglyceride ester of lactic acid |
| | Dioctyl sodium sulfosuccinate |
| | Monoglyceride ester of phosphoric acid |
| | Diglyceride ester of phosphoric acid |
| | Lecithin |
| | Hydoxylated lecithin |
| | Lysolecithin |
| Non ionic | Polysorbates |
| | Sorbitan esters of myristic acid |
| | Sorbitan ester of palmitic acid |
| | Sorbitan ester of stearic acid |
| | Sorbitan ester of oleic acid |
| | Polyglycerol esters of myristic acid |
| | Polyglycerol esters of palmitic acid |
| | Polyglycerol esters of stearic acid |
| | Polyglycerol esters of oleic acid |
| | Monoglyceride esters of myristic acid |
| | Monoglyceride esters of palmitic acid |
| | Monoglyceride esters of stearic acid |
| | Monoglyceride esters of oleic acid |
| | Diglyceride esters of myristic acid |
| | Diglyceride esters of palmitic acid |
| | Diglyceride esters of stearic acid |
| | Diglyceride esters of oleic acid |
| | (ethoxy)ₙ monoglyceride esters of myristic acid* |
| | (ethoxy)ₙ monoglyceride esters of palmitic acid* |
| | (ethoxy)ₙ monoglyceride esters of stearic acid* |
| | (ethoxy)ₙ monoglyceride esters of oleic acid* |
| | (ethoxy)ₙ diglyceride esters of myristic acid* |
| | (ethoxy)ₙ diglyceride esters of palmitic acid* |
| | (ethoxy)ₙ diglyceride esters of stearic acid* |
| | (ethoxy)ₙ diglyceride esters of oleic acid* |
| | Sucrose ester of lauric acid |
| | Sucrose ester of myristic acid |
| | Sucrose ester of palmitic acid |
| | Sucrose ester of stearic acid |
| | Sucrose ester of oleic acid |
| | Propylene glycol ester of lauric acid |
| | Propylene glycol ester of myristic acid |
| | Propylene glycol ester of palmitic acid |
| | Propylene glycol ester of stearic acid |
| | Propylene glycol ester of oleic acid |
| | Modified starches such as sodium octenyl succinate starch, |
| | acetylated distarch phosphate, hydroxypropyl starch |
| | and oxidized starch |

*where n is a whole number from 10 to 30.

This process also allows the addition of tocopherol, butylated hydroxyanisole, butylated hydroxytoluene, rosemary oil or other lipophilic substances to the flavor oil for stabilization. Depending on the oil, common weighting agents such as sucrose acetate isobutyrate, brominated vegetable oil and xanthan gum can also be added to the oil to enhance emulsion stability in the concentrate or beverage.

The first step of the process includes dissolving the emulsifier in water. Any of the emulsifiers (including mixtures thereof) in Table 1 can be used. A combination of solvents, such as propylene glycol, glycerol, benzyl alcohol, triacetin, ethanol and isopropanol, and water may also be used to dissolve the emulsifier. We have discovered that besides the use of cosolvents improved results can be obtained by adding sugars (saccharides) and/or sugar alcohols to the aqueous emulsifier mixture. The following sugars and sugar derivatives have been found to be effective: sucrose, fructose, glucose, sorbitol, xylitol, mannitol, glycerol and mixtures thereof. Emulsifiers can also be dry mixed with sucrose and then dissolved. Depending on the emulsifier/emulsifier system used, heat may be applied to facilitate dissolution. In the next step flavor oil is added to the emulsifier solution and a crude emulsion is generated with high shear mixing. The crude emulsion is fed into a two stage homogenizer and subjected to several cycles of homogenization. The homogenization protocol depends on the flavor oil used. Typically, three cycles at 400 bar is adequate. After homogenization, the emulsion concentrate is diluted to the desired flavor loading in the beverage. Depending on the beverage nature, the beverages may be subjected to pasteurization. Following pasteurization, a clear solution is obtained. For beverages that do not undergo pasteurization, the clarity of the beverage is dependent on the terpene content of the flavor oil. A clear beverage can be obtained if the terpene content of the flavor is less than 75%. Pasteurization serves not only to help clarify the beverage but to sterilize it to prevent spoilage due to growth of microorganisms. Besides pasteurization, filtration and ozonation can also be used to sterilize the beverage.

Sucrose monoesters on their own were found to be excellent emulsifiers for the inventive process. Clear beverages can be obtained when only sucrose esters are employed as emulsifiers. The composition of flavor oils is highly dependent on its origin, species and processing history. Furthermore, blending of oils is common so as to achieve a particular flavor profile. Thus this solubilization process should also be robust as to cater to differences in flavor oils. Due to diversity in the range of sucrose esters in terms of fatty acid chain length and degree of esterification, adjustments in the sucrose ester blend has been found to provide a quick way of customization to different oils and nutraceuticals.

The ratio of flavor oil to emulsifier loading varies with the type of flavor oil used. For an orange flavor base with a terpene content of 75%, the ratio is 2:1 when sucrose monopalmitate is used. At this stage, a nutraceutical may be added together with flavor oil. If the nutraceutical has limited water solubility, the emulsifier loading may be increased to accommodate the increase in oil load so that a clear beverages is still obtained.

The effect of emulsifier and flavor on the loading ratios will be illustrated in the examples. However, adjustment of this ratio may be necessary to achieve clarity depending on the flavor oil or oils or emulsifier used.

In the emulsion concentrate the flavor oil is typically present at a concentration of 3% while the sucrose monopalmitate is present at a concentration of 1.5%. This translates to a flavor oil concentration in the final beverage between 25 and 100 ppm and a sucrose monopalmitate concentration of between 12.5 and 50 ppm.

Depending on the nature of flavor oil, clear beverages may not be obtained after dilution of the flavor concentrate. In such cases, pasteurization was found to ensure the clarity of the beverages. In cases where pasteurization is not permitted, the homogenization protocol can be adjusted to render the beverage clear.

The flavor concentrate obtained after homogenization may be stored for later dilution. Storage can involve the addition of thickeners and stabilizers. Another alternative is to dry the concentrate into a powder. Examples of possible drying techniques are spray drying and freeze drying. Finally, the emulsion concentrate is diluted into the beverage to achieve the desired flavor loading and pasteurized. The pasteurization step clarifies the mixture so that a clear solution is obtained.

### EXAMPLE 1

This example illustrates the formation of a beverage flavored with an orange flavor base. The emulsifier used was sucrose monopalmitate with monoester content greater than 90%.

| Step | | Actions |
|---|---|---|
| 1) | Dry mix | Dry mix 200 g sucrose and 7.5 g sucrose monopalmitate |
| 2) | Solvent mix | Mix 75 g of propylene glycol and 202.25 g of water. Heat the |
| | | mixture to 40° C. to facilitate subsequent dissolution of sucrose |
| | | and sucrose ester. |
| 3) | Sucrose/sucrose | Add the dry mix of sucrose and sucrose ester slowly into the |
| | ester dissolution | solvent mix using high shear mixer (Silverson L4R). |
| 4) | Oil addition | Add 15 g of orange flavor base to the mixture from step 3 with |
| | | high shear for 10 min (Silverson L4R) |
| 3) | Homogenization | Homogenize the emulsion at 400 bar for 3 cycles through a |
| | | APV1000 homogenizer. The concentrate solution will be less |
| | | cloudy after homogenization. |
| 4) | Addition of flavor | The resultant flavor concentrate is then dosed at 0.167% into |
| | to beverage | 12brix sugar solution to yield an orange flavored beverage that |
| | | contains 50 ppm orange oil. Citric acid is added such that the citric |
| | | acid loading in beverage is 0.1%. The resultant beverage clarity is |
| | | around 3 FTU (formazine turbidity units). |
| 5) | Pasteurization | The beverage is then pasteurized at 85° C. for 15 min. The |
| | | resultant beverage will register an FTU reading less than 2. |

### EXAMPLE 2

This example illustrates the formation of a beverage flavored with a lemon flavor base that contains less than 75% terpenes. The emulsifier used was 100% sucrose monopalmitate (monoester content greater than 90%).

| Step | | Actions |
|---|---|---|
| 1) | Dry mix | Dry mix 200 g sucrose and 7.5 g sucrose monopalmitate |
| 2) | Solvent mix | Mix 75 g of propylene glycol and 202.25 g of water. Heat the |
| | | mixture to 40° C. to facilitate subsequent dissolution of sucrose |
| | | and sucrose ester. |
| 3) | Sucrose/sucrose | Add the dry mix of sucrose and sucrose ester slowly into the |
| | ester dissolution | solvent mix using high shear mixer (Silverson L4R) |
| 4) | Oil addition | Add 15 g of lemon flavor base to the mixture from step 3 with |
| | | high shear for 10 min (Silverson L4R) |
| 3) | Homogenization | Homogenize the emulsion at 400 bar for 3 cycles through a |
| | | APV1000 homogenizer. The concentrate solution will be less |
| | | cloudy after homogenization. |
| 4) | Addition of flavor | The resultant flavor concentrate is then dosed at 0.167% into |
| | to beverage | 12brix sugar solution to yield an orange flavored beverage that |
| | | contains 50 ppm orange oil. Citric acid is added such that the citric |
| | | acid loading in beverage is 0.1%. The resultant beverage clarity is |
| | | around 3 FTU. |
| 5) | Pasteurization | The beverage is then pasteurized at 85° C. for 15 min. The |
| | | resultant beverage will register an FTU reading less than 2. |

### EXAMPLE 3

This example shows the use of sucrose monolaurate.

| Step | | Actions |
|---|---|---|
| 1) | Dry mix | Dry mix 200 g sucrose and 7.5 g sucrose monopalmitate |
| 2) | Solvent mix | Mix 75 g of propylene glycol and 202.25 g of water. Heat the |
| | | mixture to 40° C. to facilitate subsequent dissolution of sucrose |
| | | and sucrose ester. |
| 3) | Sucrose/sucrose | Add the dry mix of sucrose and sucrose ester slowly into the |
| | ester dissolution | solvent mix using high shear mixer (Silverson L4R) |
| 4) | Oil addition | Add 15 g of grapefruit base to the mixture from step 3 with high |
| | | shear for 10 min (Silverson L4R) |
| 3) | Homogenization | Homogenize the emulsion at 400 bar for 3 cycles through a |
| | | APV1000 homogenizer. The concentrate solution will be less |
| | | cloudy after homogenization, but will remain unclear. |
| 4) | Addition of flavor | The resultant flavor concentrate is then dosed at 0.167% into |
| | to beverage | 12brix sugar solution to yield an orange flavored beverage that |
| | | contains 50 ppm orange oil. Citric acid is added such that the citric |
| | | acid loading in beverage is 0.1%. |
| 5) | Pasteurization | The beverage is then pasteurized at 85° C. for 15 min. The |
| | | resultant beverage will register an FTU reading less than 2. |

The process is effective with any flavor oil/essential oil including orange oil, lemon oil, clove oil, cinnamon oil, mint oil, banana oil and other such oils well known in the art. In addition a variety of water insoluble, primarily lipophilic, nutraceutical and vitamins can be included in the emulsion concentrate. Tocopherol (vitamin E), carotenoids (beta carotene, other carotenes and xanthophylls) and vitamin D can be readily included in beverages by use of the present invention.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

1. A process for solubilizing flavor oils to produce clear beverages comprising the steps of:
mixing flavor oil into an aqueous solution of emulsifier containing at least one sucrose ester with a high shear mixer to form a crude emulsion;
homogenizing the crude emulsion to form a flavor concentrate; and
diluting the flavor concentrate into a beverage.

2. The process according to claim 1 further comprising a step of dry mixing sucrose with sucrose ester prior to the step of mixing.

3. (canceled)

4. The process according to claim 1, wherein the emulsifier comprises a mixture of emulsifiers.

5. The process according to claim 1, wherein the flavor concentrate is stored after the step of homogenizing and prior to the step of diluting.

6. The process according to claim 5, wherein storing the flavor concentrate further comprises adding thickeners and/or stabilizers.

7. The process according to claim 5, wherein storing the flavor concentrate further comprises drying the flavor concentrate to form a powder.

8. The process according to claim 1, wherein the amount of emulsifier in the crude emulsion ranges from 0.1 to 30% weight by volume.

9. The process according to claim 1, wherein the aqueous solution further contains one or more water miscible solvents selected from the group consisting of propylene glycol, glycerol, benzyl alcohol, triacetin, ethanol and isopropanol.

10. The process according to claim 1, wherein the aqueous solution further contains saccharides and/or sugar alcohols selected from the group consisting of sucrose, fructose, glucose, sorbitol, xylitol, mannitol, glycerol and mixtures thereof.

11. The process according to claim 1, wherein the flavor oil in the crude emulsion ranges from 0.2 to 30% weight by volume.

12. The process according to claim 1, wherein the beverage contains 0.005 to 0.02% weight by weight flavor oil.

13. The process according to claim 1, wherein the pH of the beverage ranges from 2 to 8.

14. The process according to claim 1, wherein the flavor oil is selected from the group consisting of lemon, berry, orange, grapefruit, tangerine, lime, kumquat, mandarin, bergamot and mixtures thereof.

15. The process according to claim 14, wherein the flavor oil also contains synthetic flavorings.

16. The process according to claim 1, wherein the flavor concentrate contains a lipophilic antioxidant selected from the group consisting of tocopherol, butylated hydroxyanisole, butylated hydroxytoluene, rosemary oil and mixtures thereof.

17. The process according to claim 1, wherein the flavor concentrate further contains a weighting agent.

18. The process according to claim 17, wherein the weighting agent is selected from the group consisting of sucrose acetate isobutyrate, brominated vegetable oil and xanthan gum.

19. The process according to claim 1, wherein the flavor concentrate further contains a nutraceutical.

20. The process according to claim 19, wherein the nutraceutical is selected from the group consisting of coenzyme Q10, omega-3 fatty acids, vitamins and carotenoids.

21. The process according to claim 1, wherein the beverage is sterilized by a process selected from the group consisting of ozonation, filtration and pasteurization.

22. The process according to claim 1, wherein the ratio of flavor oil to emulsifier is 2:1 in the flavor concentrate.

23. The process according to claim 1 further comprising the step pasteurizing the beverage to clarify it.
